(19) United States
(12) Patent Application Publication
(10) Pub. No.: US 2024/0384679 A1
(43) Pub. Date: Nov. 21, 2024

(54) INTERNAL COMBUSTION ENGINE COMPRISING A SPARK PLUG AND NEGATIVE SPARK POSITIONS

(71) Applicant: Robert Bosch GmbH, Stuttgart (DE)

(72) Inventors: Matthias Blankmeister, Heiligenhaus (DE); Sergej Subkow, Kornwestheim (DE); Thomas Steidten, Ludwigsburg (DE)

(21) Appl. No.: 18/693,097

(22) PCT Filed: Nov. 15, 2022
(86) PCT No.: PCT/EP2022/081919

§ 371 Date: Mar. 18, 2024

(30) Foreign Application Priority Data
Nov. 24, 2021 (DE) 10 2021 213 216.2

(51) Int. Cl. F02B 23/08; F02B 23/10; F02B 43/10; H01T 13/08; H01T 13/32

(52) U.S. Cl. CPC F02B 23/08; F02B 43/10; H01T 13/08; H01T 13/32; F02B 2023/102

(57) ABSTRACT

An internal combustion engine. The internal combustion engine includes: at least one cylinder in which a combustion chamber is formed, the combustion chamber being delimited by side walls of the cylinder and a combustion chamber roof, which is formed by a cylinder head of the cylinder, and a piston that can move in the cylinder; and a spark plug with a longitudinal axis including: a housing with a combustion chamber-facing end face, an insulator disposed in the housing, a center electrode disposed in the insulator, and at least one ground electrode disposed on or in the housing and, together with the center electrode, forms at least one spark gap. The spark plug is mounted in a bore formed in the cylinder head and is designed to ignite a fuel/air mixture in the combustion chamber. The spark gap of the spark plug is located outside the combustion chamber.

### FIELD

The present invention relates to an internal combustion engine. The internal combustion engine according to the present invention is in particular suitable for operation with a hydrogen-containing fuel.

### BACKGROUND INFORMATION

To date, most vehicles, such as cars or trucks, have been powered by an internal combustion engine or combustion engine that uses gasoline or diesel as fuel. Now the number of mobile and stationary internal combustion engines that use natural gas or hydrogen as fuel is increasing. As with a gasoline-powered combustion engine, the air/fuel mixture in the hydrogen-powered internal combustion engine also has to be externally ignited. Typically, a spark plug is used for this purpose.

Usually a very lean air/fuel mixture (lambda>1.8) is set in hydrogen-powered internal combustion engines, in order to comply with regulatory emission requirements. Together with the low mixture heating value of hydrogen, this results in higher charge densities and correspondingly higher pressures at the time of ignition. Another special feature of hydrogen combustion in an internal combustion engine is the interaction between the auto-ignition temperature and the minimum required ignition energy. Therefore a “cold spark plug” is required for use in a hydrogen-powered internal combustion engines, i.e., a spark plug with a very low heat value is needed. The relative position of the spark plug or the spark gap to the combustion chamber also has an important impact on the performance of the spark plug and internal combustion engine.

Spark plugs and internal combustion engines described in the related art are typically optimized for operation in a gasoline-powered internal combustion engines. The position of the spark plug in the cylinder head or the spark gap within the combustion chamber is also selected accordingly. An example of a conventional arrangement of the spark plug in the cylinder for a gasoline-powered internal combustion engine is shown in FIG. 9. The existing spark plugs and internal combustion engines are consequently not suitable for use, or provide poor performance when used in hydrogen-powered internal combustion engines.

### SUMMARY

An object of the present invention is to provide an internal combustion engine with a spark plug that meets the requirements for a hydrogen-powered internal combustion engine.

This object may be achieved in the internal combustion engine according to the present invention in that the spark gap of the spark plug is disposed outside the combustion chamber.

The internal combustion engine according to the present invention comprises at least one cylinder and a spark plug associated with the cylinder. The at least one cylinder comprises a combustion chamber, which is delimited by the side walls of the cylinder and a combustion chamber roof and a piston that can move in the cylinder. The combustion chamber roof is the surface of the cylinder head that delimits the combustion chamber. The cylinder head comprises a cylinder head bore, referred to hereafter as the bore, which extends to the combustion chamber. A spark plug is mounted in this bore, for example screwed in. The spark plug is designed to ignite a fuel/air mixture in the combustion chamber.

According to an example embodiment of the present invention, the spark plug has a longitudinal axis which extends from the end of the spark plug on the combustion chamber side to the end of the spark plug facing away from the combustion chamber. The spark plug comprises a housing with a combustion chamber-facing end face. An insulator and a center electrode are disposed in the housing, wherein the center electrode is disposed in the insulator. At least one ground electrode is disposed on or in the housing. The at least one ground electrode together with the center electrode forms a spark gap. The spark gap can in particular be formed radially or axially with respect to the longitudinal axis of the spark plug. The width of the spark gap is the distance between the mutually facing surfaces of the center electrode and the at least one ground electrode. The spark gap is the volume between the ground electrode and the center electrode that results between the overlapping projections of the oppositely disposed ignition surfaces of the electrodes onto one another. In other words, the ignition surface of the center electrode is projected onto the ignition surface of the ground electrode and vice versa. The volume covered by the two projections is the volume of the spark gap. The volume is delimited in one dimension by the ignition surfaces and in the other dimensions bounded by the overlap of the projected ignition surfaces onto one another. The spark gap has an end on the combustion chamber side. In the case of an axial spark gap, for example, this is the ignition surface of the ground electrode configured as a roof electrode. In the case of a radial spark gap, for example, this is the combustion chamber-side end of the spark gap volume between the oppositely disposed electrodes.

According to the present invention, it is provided that the spark gap of the spark plug is located outside the combustion chamber. Outside the combustion chamber means that the spark gap is flush with the combustion chamber roof inside the bore or its combustion chamber-side end, but does not extend beyond the combustion chamber roof into the combustion chamber. The spark plug has a negative spark position. This has the advantage that the electrodes do not project into the combustion chamber or project as little as possible into the combustion chamber and therefore absorb less heat from the combustion chamber. The spark plug consequently absorbs less heat and is a cold spark plug, so that unwanted auto-ignition is avoided.

Further advantageous embodiments of the present invention are disclosed herein.

According to an example embodiment of the present invention, the spark gap advantageously has a distance to the combustion chamber roof of the cylinder of at least 0 mm and at most −15 mm, in particular not less than −1 mm and/or not greater than −4 mm, for instance, wherein the contour of the combustion chamber roof is continued by an imaginary line at the bore opening, and this imaginary line is a reference plane having the value 0 mm. The sign represents the direction of the distance, not the value of the distance. The distance from the reference plane in particular increases in the direction of the end of the spark plug facing away from the combustion chamber and the negative sign symbolizes the direction starting from the reference plane away from the combustion chamber. A positive sign corresponds to a distance of the spark gap from the reference plane in the direction of the combustion chamber, i.e., into the combustion chamber. The value of the number corresponds to the length of the distance and is meant in this context when specifying limits for the distance. The distance is measured parallel to the longitudinal axis of the spark plug. The distance is measured from the combustion chamber-side end of the spark gap to the reference plane.

According to an example embodiment of the present invention, the feature that the distance between the spark gap and the combustion chamber roof is greater than −0 mm means that the spark gap is located completely inside the bore, i.e., the spark plug has a negative spark position. This has the advantage that the electrodes are pulled as far as possible out of the combustion chamber and therefore absorb as little heat as possible from the combustion processes taking place in the combustion chamber. This makes it possible to obtain a spark plug that is as cold as possible.

Limiting the distance to at most −15 mm has the advantage that the flames created at the spark gap do not have to travel too far to reach the combustion chamber. A distance of −1 mm to −4 mm between the spark gap and the combustion chamber roof has proven to be a good compromise for reduced heat absorption by the spark plug from the combustion chamber and good and sufficiently quick propagation of flames from the spark gap to the combustion chamber. The larger the wall thickness of the spark plug housing, the smaller the distance between the spark gap and the combustion chamber roof can be. The ratio V of the wall thickness B of the spark plug housing to the distance A (V=B/A) is from 0.05 to 25; the value V is preferably from 0.5 to 5. The wall thickness B of the spark plug housing results from the difference in the outer radius RA of the housing in the threaded region, wherein the threaded tips belong to the outer diameter of the housing, and the inner radius RI of the housing in the breathing space is: B=RA-RI, wherein the radius is measured from and perpendicular to the longitudinal axis of the spark plug.

In an advantageous configuration of the internal combustion engine of the present invention, the combustion chamber-facing end face of the housing is disposed outside the combustion chamber. This has the advantage that the ground electrode can also be formed on the end face of the housing, for example as a roof electrode or as a side electrode, while retaining the advantage of the cold spark plug.

In another advantageous configuration of the internal combustion engine of the present invention, the combustion chamber-facing end face of the housing is at least partly flush, in particular completely flush, with the combustion chamber roof. This has the advantage that the housing conforms to the combustion chamber roof and makes the opening created by the bore in the cylinder head smaller. This reduces the influence of the housing on the flow in the combustion chamber. This advantage is further enhanced, if the combustion chamber-side end face of the housing also has a shape that corresponds to the contour of the combustion chamber roof.

In a further development of the internal combustion engine according to the present invention, the spark plug is disposed within a region of the cylinder head, wherein the region is a circular area with a midpoint of the combustion chamber roof as the center of the circle and has a radius R_{M} of 15% of the inner cylinder radius R_{B}. When assessing whether the spark plug is disposed within the region, the longitudinal axis of the spark plug is considered. If the longitudinal axis is within the region, the spark plug is deemed to be disposed within the region. The spark plug is in particular disposed at the midpoint of the combustion chamber roof. In other words, the longitudinal axis of the spark plug and the midpoint of the combustion chamber roof coincide. This central arrangement of the spark plug in the cylinder head and the combustion chamber roof has the advantage that the spark plug is disposed centrally and therefore the flame front generated by the spark plug can spread evenly in the combustion chamber.

In an alternative further development of the internal combustion engine according to the present invention, the spark plug is disposed outside a region of the cylinder head, wherein the region is a circular area with a midpoint of the combustion chamber roof as the center of the circle and has a radius R_{M} of 15% of the inner cylinder radius R_{B}. When assessing whether the spark plug is disposed outside the region, the longitudinal axis of the spark plug is considered. If the longitudinal axis is outside the region or on the edge of the region, the spark plug is deemed to be disposed outside the region. In other words, any arrangement of the spark plug that is not within the region is considered to be outside the region. This decentralized arrangement of the spark plug in the cylinder head and combustion chamber roof has the advantage that the spark plug is disposed laterally in the combustion chamber roof, which enables an aligned arrangement with respect to possible fuel injector or charge exchange openings of the cylinder. The aligned arrangement of the spark plug to possible further components in the cylinder provides the ability to optimize the performance of the internal combustion engine to the corresponding arrangement.

In an advantageous configuration of the internal combustion engine according to an example embodiment of the present invention, the combustion chamber-facing end face of the housing comprises a surface that corresponds to the contour of the combustion chamber roof. The combustion chamber roof can have different shapes, for example a flat surface or a conical surface, which has its midpoint on the longitudinal axis of the cylinder. The conical surface have the shape of a hemisphere or one or more curved or straight surfaces, for instance, that meet at the midpoint of the surface. When looking at a cross-section along the longitudinal axis of the cylinder, the combustion chamber roof has correspondingly different contours: straight lines, curved line, etc.

According to an example embodiment of the present invention, the combustion chamber-facing end face of the housing advantageously has a surface that corresponds to the shape or the contour of the combustion chamber roof. Since this makes the combustion chamber-side opening of the bore in the cylinder head smaller, this advantage is particularly pronounced if the combustion chamber-facing end face of the housing is also flush with the combustion chamber roof. The opening on the combustion chamber roof created by the bore in the cylinder head affects the flow of the fuel/air mixture and the propagation of flames in the combustion chamber. The smaller the opening in the combustion chamber roof, the less disrupted the flow of the fuel/air mixture and the propagation of flames in the combustion chamber. Moreover, less mixture flows from the combustion chamber into the opening of the bore or into the breathing space of the spark plug, as a result of which less heat is transferred from the mixture to the electrodes or the housing or the spark plug and the electrodes, the housing and therefore also the spark plug do not absorb too much heat.

In an advantageous further development of the present invention, the surface of the combustion chamber-facing end face of the housing is a flat surface that is perpendicular to the longitudinal axis of the spark plug. This further development has the advantage that no other process steps are necessary in the production of the housing of the spark plug, because the housing typically has a flat combustion chamber-facing end surface, which is aligned perpendicular to the longitudinal axis of the spark plug. This shape of the end face of the spark plug housing is particularly advantageous in combination with the arrangement of the spark plug within the region of the cylinder head around the midpoint of the combustion chamber roof, in particular if the end surface of the housing is flush with the combustion chamber roof. This shape of the combustion chamber-facing end face of the spark plug housing is also particularly advantageous if the combustion chamber-facing end face of the housing is disposed inside the bore. Spark plugs comprising a flat combustion chamber-facing end surface of the housing can be used in cylinders with a variety of combustion chamber roof contours.

In an alternative advantageous further development of the present invention, the surface of the combustion chamber-facing end face of the housing is a flat surface which includes an angle a of less than 90°, and in particular greater than 30°, with the longitudinal axis of the spark plug, wherein in each case the smaller included angle between the surface and the longitudinal axis is considered. Especially with a decentralized arrangement of the spark plug and a flush arrangement of the combustion chamber-facing end face of the housing with the combustion chamber roof, this has the advantage that the end face hugs the contour of the combustion chamber roof better than a spark plug comprising a surface of the combustion chamber-facing end face of the housing that is flat and is aligned perpendicular to the longitudinal axis of the spark plug. With a decentralized arrangement of the spark plug comprising a combustion chamber-facing end face of the housing that is flat and is aligned perpendicular to the longitudinal axis of the spark plug, a flush arrangement of the combustion chamber-facing end face of the housing is only partly possible, because a part or section of the housing either projects into the combustion chamber or ends inside the bore. This creates edges on the combustion chamber roof that are unfavorable for the flow of the fuel/air mixture in the combustion chamber and disrupt the flow. This effect is avoided if the combustion chamber-facing end face of the housing is flat and angled with respect to the longitudinal axis.

In another alternative advantageous further development of the present invention, the surface of the combustion chamber-facing end face of the housing has the shape of a curved surface that includes an angle a of less than 90°, and in particular greater than 30°, with the longitudinal axis of the spark plug, wherein in each case the smaller included angle between the surface and the longitudinal axis X is considered. For this purpose, a tangent is applied to the curved surface at the point at which the curved surface intersects the longitudinal axis of the spark plug when the curved surface is viewed in section and projected into a plane together with the longitudinal axis of the spark plug. The applied tangent includes an angle of 30° to 150° with the longitudinal axis of the spark plug. Spark plugs comprising a curved combustion chamber-facing end face of the housing are particularly advantageous in a decentralized and flush arrangement of the spark plug in a cylinder head with a curved combustion chamber roof, because the above-described advantages are achieved here as well.

In a further development of the present invention, it is provided that the cylinder, in particular the cylinder head, and/or the spark plug each have a mark, so that the spark plug can be mounted in the cylinder in an aligned manner. This has the advantage that, when mounting the spark plug in the cylinder head, the angle of rotation and the torque can be selected such that, for spark plugs of which the combustion chamber-facing end face of the housing has an angle to the longitudinal axis of the spark plug, mounting can be carried out in such a way that the combustion chamber-side end face of the housing is mounted correctly aligned in accordance with the contour of the combustion chamber roof. This is particularly advantageous if the spark plug is arranged decentrally in the cylinder head and the combustion chamber-facing end face of the housing should be arranged such that it is flush with the combustion chamber roof.

In a further configuration of the internal combustion engine according to the present invention, the spark plug comprises a thread on the outer side of the housing, with which the spark plug is screwed into the bore formed in the cylinder head, and an outer sealing surface, wherein, between the outer sealing surface and an end of the thread facing away from the combustion chamber, the housing comprises a non-threaded region which is in particular longer in the longitudinal axis of the spark plug than a thickness of an outer seal disposed on the outer sealing surface. This has the advantage that, in the event of a temperature-induced elongation of the housing in the threaded region, the spark plug still has good contact with the cylinder head in the threads facing the combustion chamber, and therefore also good heat transfer, so that the spark plug or its electrodes do not become too warm. In a further development, the non-threaded region has a length that is at least 1.4 times the thickness of the outer seal, measured parallel to the longitudinal axis of the spark plug.

The internal combustion engine according to the present invention can also comprise a spark plug in which the at least one ground electrode is disposed inside the housing. The ground electrode is in particular inserted into a bore formed in the housing wall. The ground electrode can be welded and/or pressed into the bore. The bore can be formed in the threaded region or below the threaded region. The at least one ground electrode can be arranged relative the center electrode in such a way that the electrodes form an axial or radial spark gap.

In a configuration of the internal combustion engine according to the present invention, a width of the spark gap is specified by an electrode distance between the center electrode and the at least one ground electrode, wherein the electrode distance between the center electrode and the at least one ground electrode is not greater than 0.4 mm, in particular not greater than 0.2 mm, and not less than 0.05 mm, in particular not less than 0.1 mm. This has the advantage that less voltage is needed for ignition and the increase in the electrode spacing over the operating time of the spark plug is smaller. Since the installation space inside the housing is inherently limited, the small electrode spacing advantageously also makes it possible to dispose the electrodes, and thus also the spark gap, at least partly within the housing. This results in the advantage that the electrodes do not project into the combustion chamber as much and therefore absorb less heat from the combustion chamber. The spark plug consequently absorbs less heat overall and is a cold spark plug, so that unwanted auto-ignition is avoided.

According to an example embodiment of the present invention, the electrode spacing is advantageously not greater than 0.2 mm, for instance, in particular not greater than 0.15 mm. The smaller the electrode spacing, the lower the voltage required to generate an ignition spark. It is also advantageous that the electrode spacing is at least 0.05 mm, in particular not less than 0.1 mm. The electrode spacing is therefore not too small. A very small electrode spacing poses particular challenges in terms of accuracy in spark plug production. A deviation from the ideally parallel alignment of the electrode ignition surfaces has a greater effect with a small electrode spacing, for example uneven wear on the ignition surface, than with a larger electrode spacing. The lower limit for the electrode spacing is therefore a good compromise between a small electrode spacing to reduce the ignition voltage requirement and wear, on the one hand, and, on the other hand, a justifiable amount of effort for a consistently good quality of the alignment of the ignition surfaces to one another during spark plug production.

According to an example embodiment of the present invention, the spark plug can also comprise a plurality of ground electrodes that each form a respective spark gap with the center electrode. The above-described configurations for the electrodes and a spark gap also apply accordingly to a plurality of ground electrodes and spark gaps. Since the spark plug comprises a plurality of ground electrodes, the wear on the ignition surface can be distributed over a plurality of ground electrodes and the ignition surface of the individual ground electrode does not require as much volume of a wear-resistant material as it does for a single ground electrode. The service life of the spark plug is increased. The two ground electrodes are disposed symmetrically on the inside of the housing, for instance. The longitudinal axis of the spark plug is the axis of symmetry for the arrangement of the ground electrodes. The symmetrical arrangement of the ground electrodes results in the technical effect that the flow of the fuel/air mixture within the breathing space is very uniform, which further promotes good ignition and good ignition stability of the fuel/air mixture in the spark plug.

According to an example embodiment of the present invention, the at least one ground electrode and/or the center electrode each comprise an ignition surface that is made of a different material than the rest of the electrode and forms the spark gap with the opposite electrode, for instance, and the ignition surface(s) consist of a precious metal or a precious metal alloy, in particular Pt, Ir, Rh, Pd, Re, Au or an alloy thereof. An alloy with a high Ir content, i.e., Ir is the element with the highest individual content in the alloy, is particularly advantageous here. These elements or the alloy comprising these elements are particularly wear-resistant. The electrode itself is made of nickel or a nickel alloy, for example.

The housing is made of a steel, a low-carbon steel or a stainless steel, for example.

The spark plug in particular does not comprise a cap or the like on the combustion chamber-facing end face of the housing. The housing is open at its combustion chamber-side end, so that a mixture exchange between the interior of the housing, the breathing space of the spark plug, and the combustion chamber can take place.

The internal combustion engine is advantageously configured to be operated with hydrogen or a hydrogen mixture as fuel. The internal combustion engine is in particular is configured to be operated, at least within a partial operating range, with a lambda number of at least 1.8.

### BRIEF DESCRIPTION OF THE DRAWINGS

FIG. 1 shows a first example of the internal combustion engine according to the present invention with a spark plug with a negative spark position in the cylinder head.

FIG. 2 shows a second example of the internal combustion engine according to the present invention with a spark plug with a negative spark position in the cylinder head.

FIG. 3 shows a third example of the internal combustion engine according to the present invention with a spark plug with a negative spark position in the cylinder head.

FIG. 4 shows a fourth example of the internal combustion engine according to the present invention with a spark plug with a negative spark position in the cylinder head.

FIG. 5 shows an example of a spark plug that can be used in the internal combustion engine according to the present invention and comprises a flat combustion chamber-facing end face which is aligned at an angle to the spark plug longitudinal axis.

FIG. 6 shows an example of a spark plug that can be used in the internal combustion engine according to the present invention and comprises a curved combustion chamber-facing end face which is aligned at an angle to the spark plug longitudinal axis.

FIG. 7 shows an example of a spark plug that can be used in the internal combustion engine according to the present invention.

FIG. 8 shows another example of a spark plug that can be used in the internal combustion engine according to the present invention.

FIG. 9 shows an internal combustion engine according to the related art, in which the spark plug is disposed in the cylinder head with a positive spark position.

### DETAILED DESCRIPTION OF EXAMPLE EMBODIMENTS

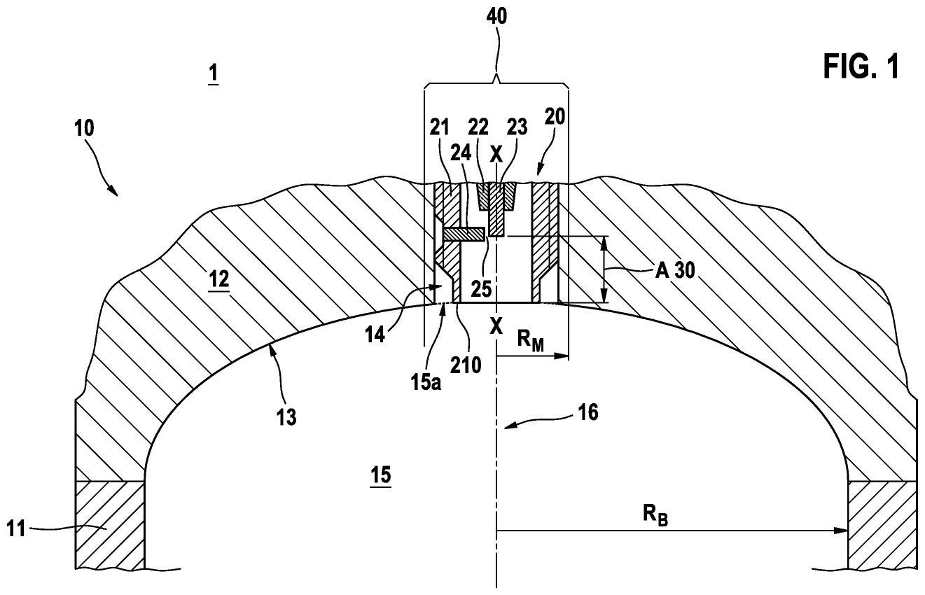

FIG. 1 shows a simplified sectional view of an internal combustion engine 1 according to a first embodiment example of the present invention. The internal combustion engine 1 can comprise a plurality of cylinders 10, wherein only one of the cylinders 10 is shown in FIG. 1. The cylinder 10 comprises a combustion chamber 15, which is delimited by a piston that can move in the cylinder, the side walls 11 of the cylinder and, at its upper end, by a combustion chamber roof 13. The combustion chamber roof 13 is formed by a cylinder head 12 of the internal combustion engine 1. The combustion chamber roof 13 is preferably conical or configured such that it tapers toward the top, wherein in particular a peak of the roof forms the midpoint of the combustion chamber roof 13. The midpoint is in the center, in particular on a central axis 16, of the, preferably circular, cylinder 10. The cylinder has an inner radius R_{B}, which extends from the central axis 16 of the cylinder to a side wall 11 of the cylinder.

Not shown here, the cylinder 10 can comprise charge exchange openings, such as at least one inlet opening, through which fresh air can flow into the combustion chamber 15 and at least one outlet opening, through which exhaust gases can flow out of the combustion chamber 15 after combustion. For each cylinder 10, the internal combustion engine 1 can also comprise a combustion chamber fuel injector which is configured to inject fuel directly into the combustion chamber 15, or an intake manifold fuel injector which is configured to inject fuel into an intake manifold that is connected to the combustion chamber 15 via the inlet opening.

The internal combustion engine 1 further comprises one spark plug 20 per cylinder 10. The spark plug 20 comprises a housing 21, an insulator 22, a center electrode 23 and a ground electrode 24. The center electrode 23 is disposed at least partly in the insulator 22, which in turn is disposed at least partly inside the housing 21. The ground electrode 24 is disposed on or in housing 21. The spark plug 20 is a spark plug which is configured to ignite a fuel/air mixture in the combustion chamber 15 by means of an electric spark. For this purpose, the spark plug 20 comprises a center electrode 23 and a ground electrode 24, which together form a spark gap 25. The ignition spark can be produced between the two electrodes 23, 24. The spark gap 25 can be located radially or axially with respect to a longitudinal axis X of the spark plug 20. The spark gap 25 has a volume that is delimited on the one hand by the oppositely disposed surfaces of the electrodes 23, 24 and by the overlapping projections of these surfaces onto one another.

The spark plug 20 further comprises a housing 21, which comprises a thread 211 on its outer side, for example, with which the spark plug 20 can be screwed into the bore 14. As shown in FIG. 1, the spark plug 20 can be disposed in a bore 14 inside the cylinder head 12, wherein the bore 14 opens into the combustion chamber 15.

In the first embodiment example shown in FIG. 1, the spark plug 20 is disposed within a region 40. The region 40 results as a circular area on the combustion chamber roof 13, wherein the circular area has the midpoint of the combustion chamber roof 13 as the center of the circle. In this example, the midpoint of the combustion chamber roof 13 and the central axis 16 of the cylinder 10 coincide. The circular area of the region 40 has a radius R_{M} which is 15% of the inner cylinder radius R_{B}. When assessing whether the spark plug 20 is disposed within the region 40, the longitudinal axis X of the spark plug 20 is considered. If the longitudinal axis X is within the region 40, the spark plug 20 is deemed to be disposed within the region 40. The spark plug 20 is in particular disposed at the midpoint of the combustion chamber roof 13. In other words, the longitudinal axis X of the spark plug 20 and the midpoint of the combustion chamber roof 13 coincide.

The spark plug 20 is disposed in the bore 14 such that its combustion chamber-facing end face 210 of the housing 21 is flush with the combustion chamber roof 13. The combustion chamber-facing end face 210 of the housing 21 is moreover a flat surface which is aligned perpendicular to the longitudinal axis X of the spark plug 20.

The combustion chamber roof 13 can be a curved surface as shown in FIG. 1. The combustion chamber roof 13 can alternatively also be composed of a plurality of flat surface segments that meet in the midpoint of the combustion chamber roof 13.

The cylinder head 12 comprises a bore 14 that penetrates the combustion chamber roof 13. The spark plug 20 is mounted in the bore 14, for example screwed in. To assess whether the spark gap 25 of the spark plug 20 is disposed outside the combustion chamber, the contour of the combustion chamber roof is continued by an imaginary line 15a in the region of the bore. This imaginary line 15a serves as the reference plane with the value 0 mm. The distance A 30 between the spark gap 25 and the reference plane is greater than 0 mm, wherein the sign indicates the direction of the distance A 30. A “+” sign means that the distance extends from the reference plane into the combustion chamber. A “−” sign means that the distance extends from the reference plane outside and away from the combustion chamber. The spark gap 25 advantageously has a distance 30 of at least 0 mm and up to −15 mm from the reference plane. The distance is from −1 mm to −4 mm, for instance.

In the following figures, identical parts of the figures have identical designations and identical reference signs. For the sake of simplicity, the differences to the previous figures are described in the subsequent figures.

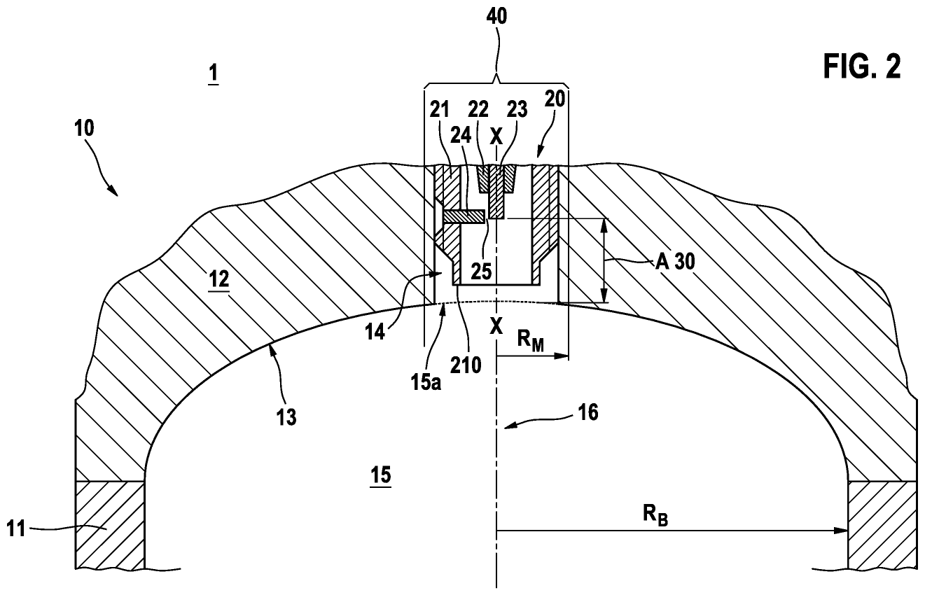

FIG. 2 shows a simplified sectional view of an internal combustion engine 1 according to the present invention according to a second embodiment example. The second embodiment example differs from the first embodiment example in that the combustion chamber-facing end face 210 of the housing 21 of the spark plug 20 ends inside the bore 14. In this example, the ground electrode 24 is disposed in a bore 214 in the housing 21 and as a side electrode forms a radial spark gap 25 together with the center electrode 23. The ground electrode 24 could alternatively be disposed inside the housing 21 such that it is a roof electrode and together with the center electrode 23 forms an axial spark gap 25. In another alternative, the ground electrode 24 can also be disposed on the combustion chamber-facing end face 210 of the housing 21, so that the spark gap 25 is not formed inside, as in FIG. 2, but outside the housing 21. It is important here that the electrodes 23, 24 are disposed in such a way that the spark gap 24 is formed inside the bore 14 in the cylinder head 12, so that the spark plug 20 mounted in the cylinder 10 has a negative spark position.

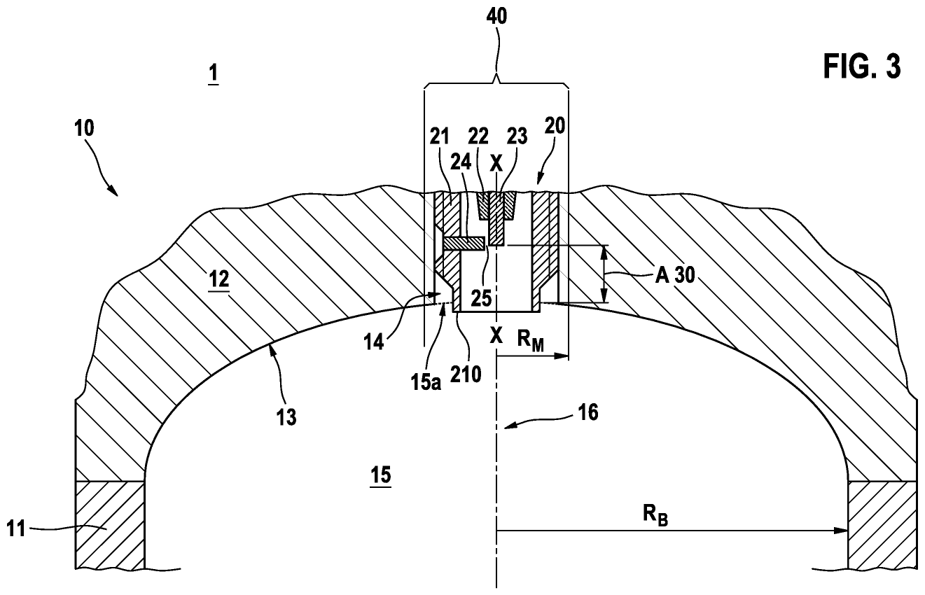

FIG. 3 shows a simplified sectional view of the internal combustion engine 1 according to the present invention according to a third embodiment example. The third embodiment example differs from the first and the second embodiment examples in that the combustion chamber-facing end face 210 of the housing 21 of the spark plug 20 ends in the combustion chamber 15. The ground electrode 24 is disposed inside the housing 21, so that the spark gap 25 is also formed inside the housing 21 and outside the combustion chamber 15. As shown, the ground electrode 24 can be disposed as a side electrode, which together with the center electrode 23 forms a radial spark gap 25, or as a roof electrode, which together with the center electrode 23 forms an axial spark gap 25.

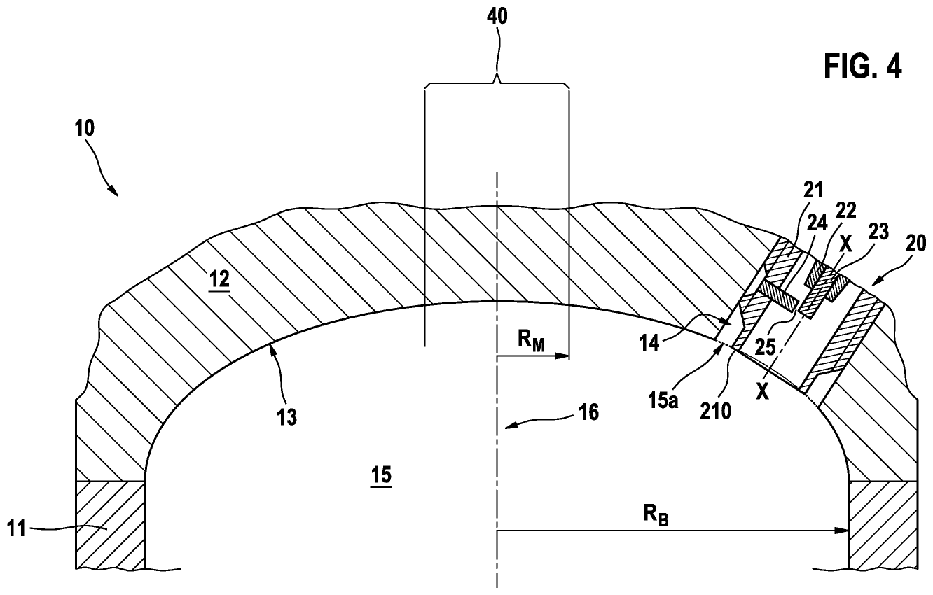

FIG. 4 shows a simplified sectional view of the internal combustion engine 1 according to the present invention according to a fourth embodiment example. The fourth embodiment example differs from the first embodiment example in that the bore 14 in the cylinder head 12 and thus also the spark plug 20 are disposed decentrally, i.e., outside the circular region 40, which has the midpoint of the combustion chamber roof as the center of the circle. The spark plug 20 is disposed inside the bore 14 such that the combustion chamber-facing end face 210 is at least partly flush with the combustion chamber roof 15. In particular if the combustion chamber-facing end face 210 of the housing 21 is a flat surface and the combustion chamber roof 13 has a non-straight contour in the region around the bore 14, the combustion chamber-facing end face 210 of the housing can only be partly flush with the combustion chamber roof 13.

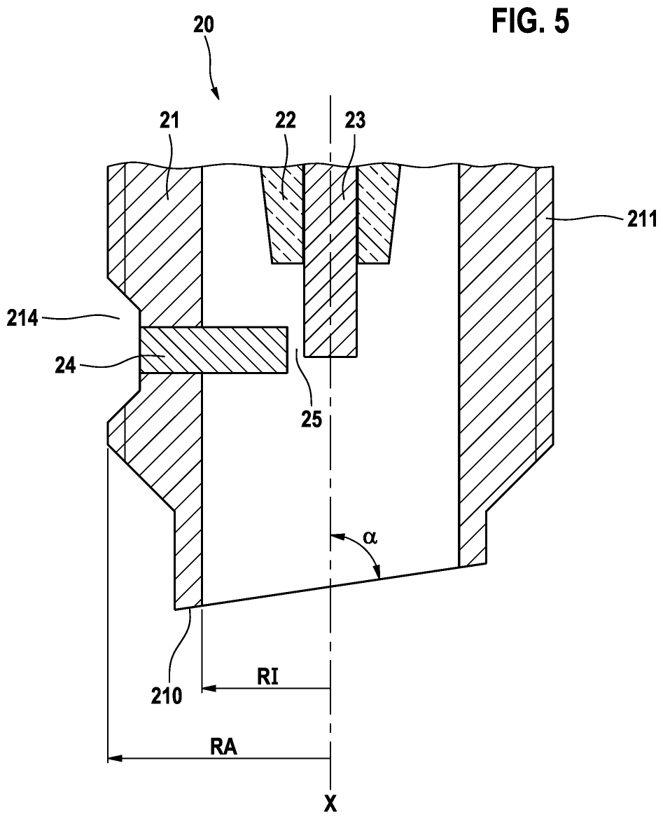

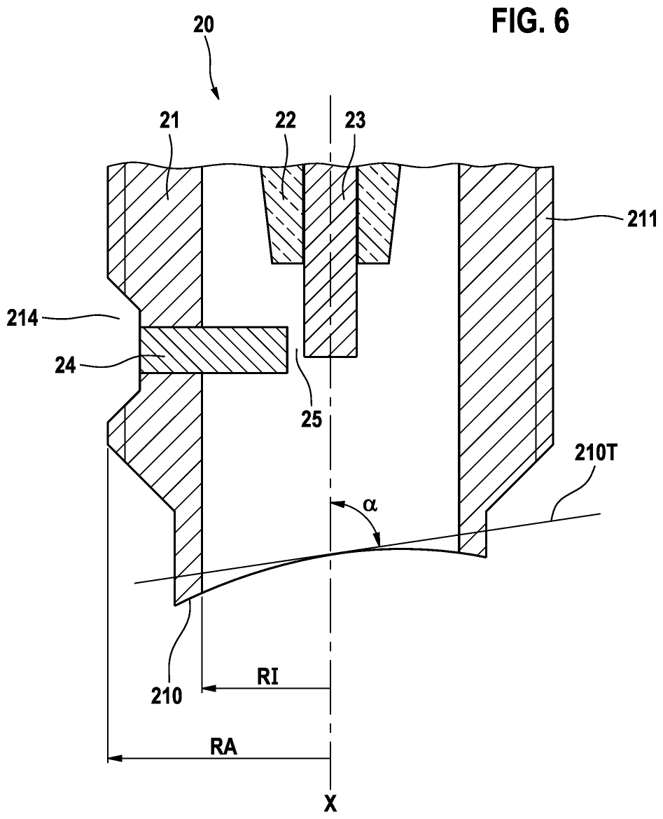

FIGS. 5 and 6 show respective sectional views of the combustion chamber-side end region of the spark plug 20. Sections of the housing 21, the insulator 22 and the center electrode 23 can be seen. The inner radius RI of the housing in the breathing space and the outer radius RA of the housing are shown. The outer radius RA extends from the longitudinal axis X of the spark plug 20 to the threaded tip of the thread 211 formed on the outer side of the housing 21. The inner radius RI extends from the longitudinal axis X of the spark plug 20 to the inside of the housing 21 in the breathing space. In this example, the ground electrode 24 is disposed in a bore 214 in the region of the thread 211 and together with the center electrode 23 forms a radial spark gap 25. The spark gap 25 is delimited radially by the oppositely disposed surfaces of the electrodes 23, 24 and delimited axially by the volume 251 of the projection of the oppositely disposed surfaces of the electrodes 23, 24. The boundaries of the projection are indicated with a broken line. The distance A 30 between the spark gap 25 and the combustion chamber roof 15 is measured from the combustion chamber-side end of the spark gap. The dashed lines illustrate the boundaries of the spark gap volume 251.

The combustion chamber-facing end face 210 of the housing 21 in FIGS. 5 and 6 differs from the combustion chamber-facing end face 210 of the housing 21 shown in the first four figures in that the combustion chamber-facing end face 210 is not a surface aligned perpendicular to the longitudinal axis X of the spark plug 20. In FIG. 5, the combustion chamber-facing end face 210 is a flat surface that is aligned at an angle to the longitudinal axis X of the spark plug 20. The surface of the end face 210 and the longitudinal axis X include an angle a. In FIG. 6, the combustion chamber-facing end face 210 is a curved surface that is aligned at an angle to the longitudinal axis X of the spark plug 20. A tangent 210T is applied to the curved surface, which together with the longitudinal axis X includes an angle a. Spark plugs 20 comprising combustion chamber-facing end faces 210 of the housing 21 that are aligned at an angle to the longitudinal axis X of the spark plug are particularly advantageous in a decentralized arrangement of the spark plug 20 in the cylinder head 12, wherein the combustion chamber-facing end face 210 of the spark plug housing 21 is flush with the combustion chamber roof 13.

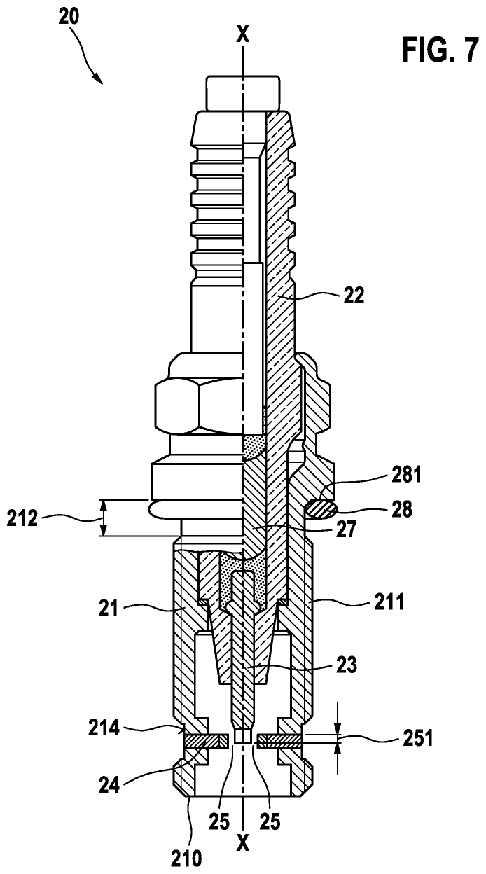

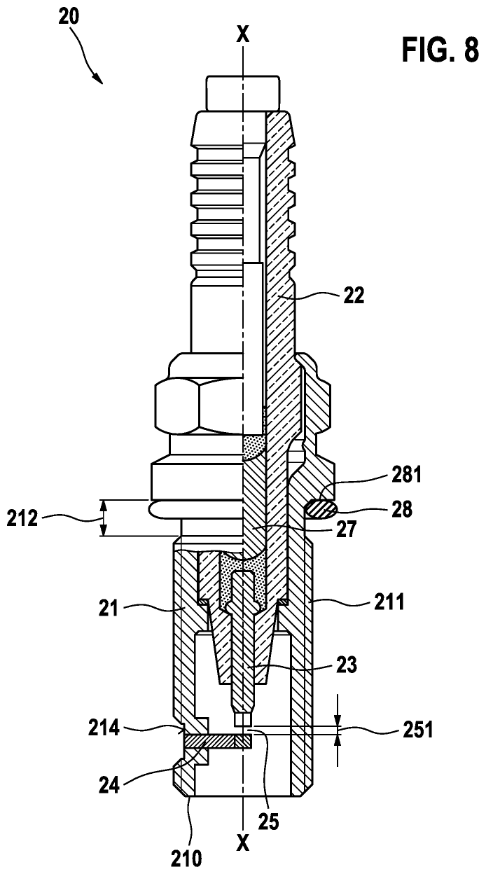

FIG. 7 and FIG. 8 show two alternative spark plugs 20 that can be used in the internal combustion engine 1 according to the present invention. FIG. 7 shows a spark plug 20 comprising a plurality of ground electrodes 24. The ground electrodes 24 each form a spark gap 25 with the center electrode 23. The ground electrodes 24 are configured here as side electrodes, which respectively form radial spark gaps 25 together with the center electrode 23.

In FIG. 8, the ground electrode 24 is configured as a roof electrode, which together with the center electrode 23 forms an axial spark gap 25. The spark plug 20 can, of course, also comprise a roof electrode in combination with one or more side electrodes as ground electrodes.

FIGS. 7 and 8 show the entire length of the spark plug 20. An outer sealing surface 281 formed on the outer side of the housing 21 above the end of the thread facing away from the combustion chamber 211 can be seen as well. A sealing ring 28 is disposed on the outer sealing surface 281 as an outer seal which seals the transition between the spark plug 20 and the cylinder head 12 when the spark plug 20 is mounted in the cylinder head 12. Between the outer sealing surface 281 and the end of the thread facing away from the combustion chamber, the housing 21 comprises a non-threaded region 212. This region in particular has a length which, measured parallel to the longitudinal axis X of the spark plug 20, is longer than a thickness of the outer seal 28 disposed on the outer sealing surface 281.

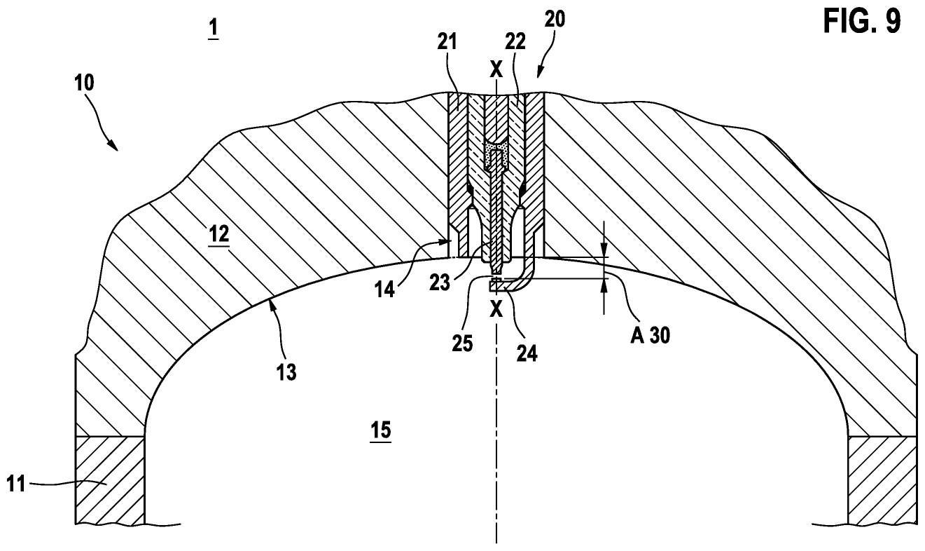

FIG. 9 shows an internal combustion engine with a conventional arrangement of the spark plug in the cylinder head. The spark plug is configured and disposed in the cylinder head such that the electrodes 23, 24 and the spark gap 25 are inside the combustion chamber. This spark plug has a positive spark position.

1-14. (canceled)

15. An internal combustion engine, comprising:
at least one cylinder in which a combustion chamber is formed, wherein the combustion chamber is delimited by side walls of the cylinder and a combustion chamber roof, which is formed by a cylinder head of the cylinder, and a piston that can move in the cylinder; and
a spark plug with a longitudinal axis, the spark plug including: a housing with an end face which faces the combustion chamber, an insulator which is disposed in the housing, a center electrode which is disposed in the insulator, and at least one ground electrode which is disposed on or in the housing and together with the center electrode forms at least one spark gap, wherein the spark plug is mounted in a bore formed in the cylinder head and is configured to ignite a fuel/air mixture in the combustion chamber;
wherein the spark gap of the spark plug is located outside the combustion chamber.

16. The internal combustion engine according to claim 15, wherein the spark gap has a distance to the combustion chamber roof of the cylinder of at least 0 mm and at most-15 mm, wherein a contour of the combustion chamber roof is continued by an imaginary line at the bore and the imaginary line is a reference plane having a value of 0 mm.

17. The internal combustion engine according to claim 15, wherein the combustion chamber-facing end face of the housing is disposed outside the combustion chamber, inside the bore for the spark plug.

18. The internal combustion engine according to claim 15, wherein the combustion chamber-facing end face of the housing is at least partly flush with the combustion chamber roof.

19. The internal combustion engine according to claim 15, wherein the spark plug is disposed within a region, wherein the region is a circular area with a midpoint of the combustion chamber roof as a center of the circular areas and has a radius f 15% of an inner cylinder radius.

20. The internal combustion engine according to claim 15, wherein the spark plug is not disposed outside a region, wherein the region is a circular area with a midpoint of the combustion chamber roof as a center of the circular area and has a radius of 15% of an inner cylinder radius.

21. The internal combustion engine according to claim 15, wherein the combustion chamber-facing end face of the housing includes a surface, wherein a shape of the surface corresponds to a contour of the combustion chamber roof.

22. The internal combustion engine according to claim 21, wherein the surface is a flat surface perpendicular to the longitudinal axis of the spark plug.

23. The internal combustion engine according to claim 21, wherein the surface is a flat surface that includes an angle of less than 90° and greater than 30°, with the longitudinal axis of the spark plug, wherein in each case a smaller included angle between the surface and the longitudinal axis is considered.

24. The internal combustion engine according to claim 22, wherein the surface is a curved surface that includes an angle of 90° and greater than 30°, with the longitudinal axis X of the spark plug, wherein in each case the smaller included angle between the surface and the longitudinal axis is considered.

25. The internal combustion engine according to claim 24, wherein the cylinder head (and/or the spark plug each have a mark, so that the spark plug can be mounted in the cylinder in an aligned manner.

26. The internal combustion engine according to claim 15, wherein the spark plug includes a thread on an outer side of the housing, with which the spark plug is screwed into the bore formed in the cylinder head, and an outer sealing surface, wherein, between the outer sealing surface and an end of the thread facing away from the combustion chamber, the housing includes a non-threaded region which is longer in the longitudinal axis of the spark plug than a thickness of an outer seal disposed on the outer sealing surface.

27. The internal combustion engine according to claim 15, wherein a width of the spark gap is specified by an electrode spacing between the center electrode and the at least one ground electrode, wherein the electrode spacing between the center electrode and the at least one ground electrode is not greater than 0.4 mm and not less than 0.05 mm.

28. The internal combustion engine according to claim 15, wherein the internal combustion engine can be operated with hydrogen or a hydrogen mixture as a fuel at least within a partial operating range with a lambda number of at least 1.8.
